(19) United States
(12) Patent Application Publication
(10) Pub. No.: US 2026/0127749 A1
(43) Pub. Date: May 7, 2026

(54) INFORMATION PROCESSING DEVICE, INFORMATION PROCESSING METHOD, AND PROGRAM

(71) Applicant: NEC Corporation, Tokyo (JP)

(72) Inventors: Shuhei YOSHIDA, Tokyo (JP); Takashi SHIBATA, Tokyo (JP); Makoto TERAO, Tokyo (JP)

(73) Assignee: NEC Corporation, Tokyo (JP)

(21) Appl. No.: 19/360,010

(22) Filed: Oct. 16, 2025

(30) Foreign Application Priority Data
Nov. 6, 2024 (JP) 2024-194516

(51) Int. Cl. G06T 7/246

(52) U.S. Cl. CPC G06T 7/248; G06T 2207/10016; G06T 2207/20084; G06T 2207/30241

(57) ABSTRACT

To correctly track the same object in consideration of a change in appearance due to movement in direction, in an information processing device, a processor generates a trajectory fragment indicating a trajectory in which an object included in a frame image moves and including information indicating at least appearance features in each frame image. The processor calculates a correlation of the appearance features for an object pair formed by extracting an object from each of first and second trajectory fragments included in a fragment pair concerning the trajectory, and calculates an appearance similarity of the fragment pair based on the correlation and a similarity between appearance features of the object pair. The processor calculates a fragment pair similarity between the first and second trajectory fragments by using the appearance similarity, and combines trajectory fragment pairs based on the fragment pair similarity to calculate a trajectory for the same object.

### INCORPORATION BY REFERENCE

This application is based upon and claims the benefit of priority from Japanese Patent Application 2024-194516, filed on Nov. 6, 2024, the disclosure of which is incorporated herein in its entirety by reference.

### TECHNICAL FIELD

The present disclosure relates to tracking objects in a video.

### BACKGROUND ART

A technique for tracking an object in a video captured by a camera or the like has been proposed. For example, Patent Document 1 A describes a method of tracking an object by linking trajectories of the object detected in a video.
Patent Document 1: Japanese Patent Application Laid-Open under No. 2019-194857

### SUMMARY

In a method of Patent Document 1, whether to link pairs of trajectories is determined based on the similarity of the objects included in the trajectory. However, even in the case of the same object, the appearance of the object changes due to movement, a change in direction, or the like. Therefore, it is not possible to correctly determine the identity of the object only by simply comparing the similarity of the appearances.

One object of the present disclosure is to provide an information processing device capable of correctly tracking the same object in consideration of a change in appearance due to movement, a change in direction, or the like of the object.

According to an example aspect of the present invention, there is provided an information processing device including:
at least one memory configured to store instructions; and
at least one processor configured to execute the instructions to:
generate a trajectory fragment indicating at least a part of a trajectory in which an object included in a time-series frame image moves and including object information indicating time, coordinates, and an appearance feature amount in each frame image of the object;
calculate a correlation of the appearance feature amounts for an object pair formed by extracting an object one by one from each of a first trajectory fragment and a second trajectory fragment included in a trajectory fragment pair that is a pair of the trajectory fragments;
calculate an appearance similarity of the trajectory fragment pair based on the correlation and a similarity between appearance feature amounts of the object pair;
calculate a fragment pair similarity that is a similarity between the first trajectory fragment and the second trajectory fragment by using the appearance similarity; and combine a plurality of trajectory fragment pairs based on the fragment pair similarity to calculate an object trajectory for the same object.

According to another example aspect of the present invention, there is provided an information processing method executed by a computer, the method including:
generating a trajectory fragment indicating at least a part of a trajectory in which an object included in a time-series frame image moves and including object information indicating time, coordinates, and an appearance feature amount in each frame image of the object;
calculating a correlation of the appearance feature amounts for an object pair formed by extracting an object one by one from each of a first trajectory fragment and a second trajectory fragment included in a trajectory fragment pair that is a pair of the trajectory fragments;
calculating an appearance similarity of the trajectory fragment pair based on the correlation and a similarity between appearance feature amounts of the object pair;
calculating a fragment pair similarity that is a similarity between the first trajectory fragment and the second trajectory fragment by using the appearance similarity; and combining a plurality of trajectory fragment pairs based on the fragment pair similarity to calculate an object trajectory for the same object.

According to still another example aspect of the present invention, there is provided a non-transitory computer-readable recording medium storing a program causing a computer to execute processing of:
generating a trajectory fragment indicating at least a part of a trajectory in which an object included in a time-series frame image moves and including object information indicating time, coordinates, and an appearance feature amount in each frame image of the object;
calculating a correlation of the appearance feature amounts for an object pair formed by extracting an object one by one from each of a first trajectory fragment and a second trajectory fragment included in a trajectory fragment pair that is a pair of the trajectory fragments;
calculating an appearance similarity of the trajectory fragment pair based on the correlation and a similarity between appearance feature amounts of the object pair;
calculating a fragment pair similarity that is a similarity between the first trajectory fragment and the second trajectory fragment by using the appearance similarity; and combining a plurality of trajectory fragment pairs based on the fragment pair similarity to calculate an object trajectory for the same object.

### Effect

According to the present disclosure, it is possible to correctly track the same object in consideration of a change in appearance due to movement, a change in direction, or the like of the object.

### BRIEF DESCRIPTION OF THE DRAWINGS

FIG. 1 illustrates an overall configuration of an information processing device according to an example of the present disclosure;

FIG. 2 is a block diagram illustrating a hardware configuration of the information processing device;

FIG. 3 is a block diagram illustrating a functional configuration of the information processing device;

FIG. 4 is a flowchart of object trajectory calculation processing;

FIG. 5 illustrates an example of an action management system to which the information processing device of the present disclosure is applied;

FIG. 6 is a block diagram illustrating a functional configuration of another information processing device; and

FIG. 7 is a flowchart of processing by another information processing device.

### EXAMPLE EMBODIMENTS

Hereinafter, preferred example embodiments of the present disclosure will be described with reference to the drawings. In the following description, in a case where a symbol is added above a variable, the symbol is added as a superscript to the variable for convenience of notation. For example, a variable “X” to which a symbol “˜” is added above is expressed as “X^{˜}”.

### First Example Embodiment

### [Overall Configuration]

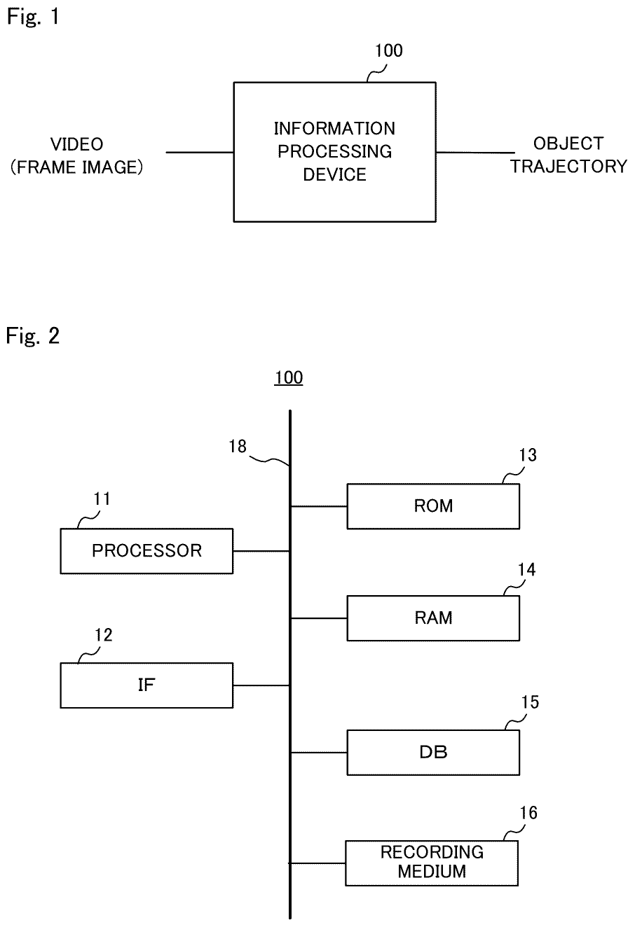

FIG. 1 illustrates an overall configuration of an information processing device according to an example of the present disclosure. The information processing device 100 tracks an object included in a video and outputs an object trajectory indicating a trajectory of the object.

A video captured by a camera or the like is input to the information processing device 100. The video to be input is a time-series frame image in which a plurality of frame images is arranged in time series. Note that a captured video may be directly input from the camera, or a video accumulated in a database or the like may be input to the information processing device 100.

Briefly, the information processing device 100 first generates a trajectory fragment for each object from a frame image. The trajectory fragment is data in which pieces of object information of the same object included in frame images of several frames are arranged in time series, and is also called a tracklet. Then, the information processing device 100 connects a plurality of trajectory fragments associated to the same object among the plurality of obtained trajectory fragments, and generates and outputs an object trajectory indicating the entire trajectory of the object. The information processing device 100 can detect the complete trajectory of the object with high accuracy by correctly connecting individual trajectory fragments that can be detected with relatively high accuracy.

### [Hardware Configuration]

FIG. 2 is a block diagram illustrating a hardware configuration of the information processing device 100. As illustrated, the information processing device 100 includes a processor 11, an interface (IF) 12, a read only memory (ROM) 13, a random access memory (RAM) 14, a database (DB) 15, and a recording medium 16. The components are connected through, for example, a bus 18.

The processor 11 is a computer such as a central processing unit (CPU), and controls the entire information processing device 100 by executing a program prepared in advance. Specifically, as the processor 11, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used.

In addition, the processor 11 loads a program stored in the ROM 13 or the recording medium 16 into the RAM 14 and executes each processing coded in the program. The processor 11 functions as a part or all of the information processing device 100. Specifically, the processor 11 executes an object trajectory calculation processing to be described later.

The IF 12 transmits and receives data to and from an external device. Specifically, the information processing device 100 receives the time-series frame images through the IF 12. Furthermore, the information processing device 100 outputs the calculated object trajectory to the display device or another external device through the IF 12.

The ROM 13 stores various programs executed by the processor 11. The RAM 14 is used as a working memory during execution of various processing by the processor 11.

The DB 15 stores various algorithms, data, machine learning models, or the like used in a case where the information processing device 100 executes object trajectory calculation processing to be described later.

The recording medium 16 is a non-volatile and non-transitory recording medium such as a disk-shaped recording medium or a semiconductor memory. The recording medium 16 may be configured to be detachable from the information processing device 100. The recording medium 16 records various programs executed by the processor 11.

In addition to the above, the information processing device 100 may include a display device such as a liquid crystal display and an input device such as a keyboard and a mouse. These display devices and input devices are used by an operator of the information processing device 100, for example.

### [Functional Configuration]

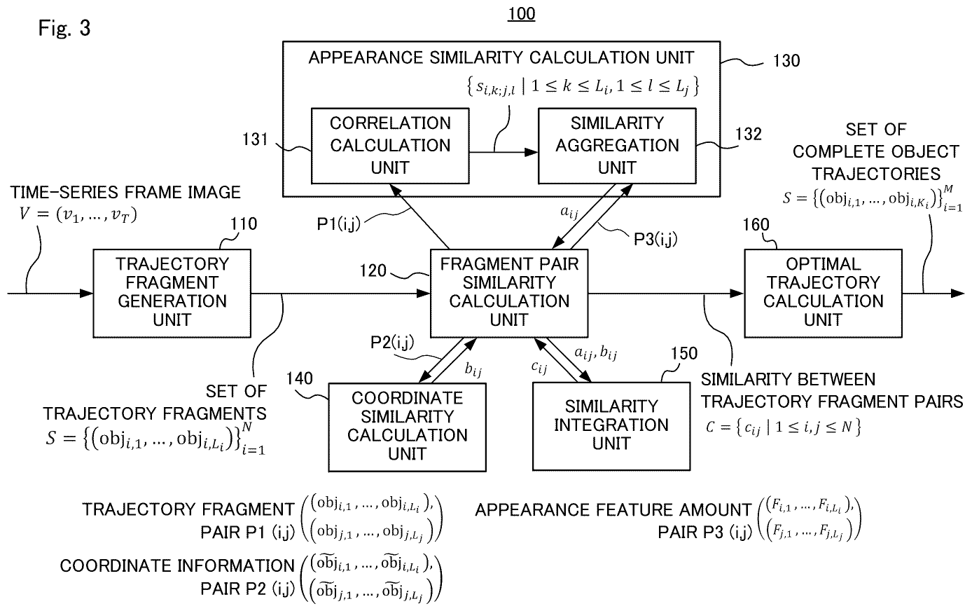

FIG. 3 is a block diagram illustrating a functional configuration of the information processing device 100. As illustrated, the information processing device 100 includes a trajectory fragment generation unit 110, a fragment pair similarity calculation unit 120, an appearance similarity calculation unit 130, a coordinate similarity calculation unit 140, a similarity integration unit 150, and an optimal trajectory calculation unit 160. In addition, the appearance similarity calculation unit 130 includes a correlation calculation unit 131 and a similarity aggregation unit 132.

In the above configuration, the trajectory fragment generation unit 110 is an example of the trajectory fragment generation means, the correlation calculation unit 131 is an example of the correlation calculation means, the similarity aggregation unit 132 and the appearance similarity calculation unit 130 are examples of the appearance similarity calculation means, the coordinate similarity calculation unit 140 is an example of the coordinate similarity calculation means, and the fragment pair similarity calculation unit 120 and the similarity integration unit 150 are examples of the fragment pair similarity calculation means.

Time-series frame images V are input to the trajectory fragment generation unit 110. The trajectory fragment generation unit 110 generates trajectory fragments from the time-series frame images V. The “trajectory fragment” is a fragment of a trajectory obtained by connecting object information obj related to the same object among objects detected in different frames.

The trajectory fragment generation unit 110 generates a trajectory fragment for each object included in the input time-series frame images V. For example, in a case where the index of the object is “i”, the trajectory fragment of an object i is expressed as (obj_{i,l}, . . . , obj_{i,Li}) by arranging pieces of the object information obj of the object i (physically the same object but detected on different frame images) included in the time-series frame images V in time order. Here, each object information obj_{i,j} includes an index (time) t_{i,j} of a frame image in which the object information obj_{i,j} is detected, coordinate (bounding box) information B_{i,j} in the frame image, and an appearance feature amount F_{i,j} of the object.

In one specific example, the trajectory fragment generation unit 110 performs object detection on each frame image included in the time-series frame images V, and detects the bounding box of the object in each frame image. Then, the trajectory fragment generation unit 110 acquires the time t of the frame image, position coordinates B of the bounding box, and the appearance feature amount F of the object included in the bounding box as the object information obj in the frame. The appearance feature amount F is a feature value expressing the appearance of the object included in the detected bounding box, and is also called a feature vector. The appearance feature amount F numerically expresses visual elements such as color, shape, and texture of an object. For example, in a case where object detection such as R-CNN is used, a feature amount extracted using a convolutional neural network (CNN) with respect to a proposal region (Rol) extracted from an input frame image can be used as the appearance feature amount F. The trajectory fragment generation unit 110 generates a trajectory fragment of each object by arranging the pieces of the object information obj associated to the same object in time series among the pieces of the object information obj in each frame acquired in this manner.

The trajectory fragment generation unit 110 generates a following set S of trajectory fragments for N objects included in the input time-series frame images V, and outputs the set S to the fragment pair similarity calculation unit 120.

$$\begin{matrix}[ Math . 1 ] & \\ S = {\{ ( {obj}_{i , 1} , … , {obj}_{i , {L}_{i}} ) \}}_{i = 1}^{N} & ( 1 )\end{matrix}$$

The fragment pair similarity calculation unit 120 uses the set S of trajectory fragments as an input, and calculates the similarity for all pairs of trajectory fragments (hereinafter, referred to as a “trajectory fragment pair”). Specifically, the fragment pair similarity calculation unit 120 calculates the similarity between each trajectory fragment pair by integrating the similarity (hereinafter, referred to as “appearance similarity”) of the appearance feature and the similarity (hereinafter, referred to as “coordinate similarity”) calculated from the variation in time/coordinates. Note that the appearance similarity is calculated by the appearance similarity calculation unit 130, and the coordinate similarity is calculated by the coordinate similarity calculation unit 140.

First, calculation of appearance similarity will be described. The fragment pair similarity calculation unit 120 inputs a trajectory fragment pair P1(i,j) illustrated in FIG. 3 to the appearance similarity calculation unit 130. The appearance similarity calculation unit 130 extracts objects one by one from the input trajectory fragment pair P1(i,j) and inputs the objects to the correlation calculation unit 131, and the correlation calculation unit 131 generates a correlation of the objects (hereinafter, referred to as “object correlation”) for all combinations of the objects. Next, in a case where the object correlation is obtained for all combinations of objects, the similarity aggregation unit 132 aggregates an appearance feature amount pair P3(i,j) and the object correlation to calculate an appearance similarity aᵢⱼ. Hereinafter, this will be described in detail.

First, the correlation calculation unit 131 calculates a following correlation s_{i,k:j,l} for all object pairs extracted from the trajectory fragment pair P1(i,j).

$$\begin{matrix}[ Math . 2 ] & \\ \{ {s}_{i , k ; j , l} \vert 1 \leq k \leq {L}_{i} , 1 \leq l \leq {L}_{j} \} & ( 2 )\end{matrix}$$

The correlation s_{i,k:j,l} is a value expressing the degree to which each object pair contributes to the appearance similarity of the trajectory fragment pair. The correlation calculation unit 131 calculates the correlation s_{i,k:j,l} based on the object information (time, coordinates, appearance feature amount) included in the input trajectory fragment pair P1(i,j).

As described above, even in the same object, the feature of the appearance changes due to the movement of the object, the change in the direction, or the like. For example, in a case where the target object is a person, the correlation between objects in a state of walking from left to right in the video is large. On the other hand, it is assumed that a person who has been walking in the right direction changes the direction and walks in the front direction in the video. In this case, the appearance features change between the person walking in the right direction and the person walking in the front direction, and thus the correlation becomes small. Therefore, by calculating the appearance similarity in consideration of the correlation value, in a case where the appearance is not similar due to movement of the object or change in the direction of the object in the video, the influence of the movement on the appearance similarity can be reduced.

In one example, the correlation calculation unit 131 can obtain the correlation s_{i,k:j,l} as follows as inner products of the appearance feature amounts.

$$\begin{matrix}[ Math . 3 ] & \\ {s}_{i , k ; j , l} = {F}_{i , k} \cdot {F}_{j , l} & ( 3 )\end{matrix}$$

In another example, the correlation calculation unit 131 can obtain the correlation s_{i,k:j,l} as follows as cosine similarity of the appearance feature amount.

$$\begin{matrix}[ Math . 4 ] & \\ {s}_{i , k ; j , l} = \frac{{F}_{i , k}}{‖ {F}_{i , k} ‖} \cdot \frac{{F}_{j , l}}{‖ {F}_{j , l} ‖} & ( 4 )\end{matrix}$$

In still another example, the correlation calculation unit 131 can use a pre-learned neural network, specifically, a multilayer perceptron (MLP) as follows to obtain the correlation s_{i,k:j,l}. In this case, the parameter of the MLP is obtained by learning in advance.

$$\begin{matrix}[ Math . 5 ] & \\ {s}_{i , k ; j , l} = MLP ( {obj}_{i} , {obj}_{j} ) & ( 5 )\end{matrix}$$

Then, the correlation calculation unit 131 outputs the correlation s_{i,k:j,l} obtained by any of the methods described above to the similarity aggregation unit 132.

The similarity aggregation unit 132 calculates the appearance similarity of the fragment pair based on the correlation calculated for all the object pairs and the series of appearance feature amounts. Specifically, the similarity aggregation unit 132 receives the correlation s_{i,k:j,l} calculated for all object pairs from the correlation calculation unit 131, and receives the appearance feature amount pair P3(i,j) from the fragment pair similarity calculation unit 120. Then, the similarity aggregation unit 132 calculates the appearance similarity aᵢⱼ for each fragment pair.

Now, let d (F_{i,k}, F_{j,l}) be the similarity between the appearance feature amount pairs F_{i,k}, F_{j,l} and let {r_{i,k:j,l}}=H ({s_{i,k:j,l}}) be the correlation modulated using a certain modulation function H. In this case, the similarity aggregation unit 132 obtains the appearance similarity aᵢⱼ by the following expression.

$$\begin{matrix}[ Math . 6 ] & \\ {a}_{ij} = {\sum }_{k , i} {r}_{i , j ; j , l} d ( {F}_{i , k} , {F}_{j , l} ) & ( 6 )\end{matrix}$$

where the modulation function His a function that satisfies the following.

$${r}_{i , k ; j , l} \geq 0 , {s}_{i , k ; j , {l}_{1}} \geq {s}_{i , k ; j , {l}_{2}} ⇒ {r}_{i , k ; j , {l}_{1}} \geq {r}_{i , k ; j , {l}_{2}}$$

$${s}_{i , {k}_{1} ; j , l} \geq {s}_{i , {k}_{2} ; j , l} ⇒ {r}_{i , {k}_{1} ; j , l} \geq {r}_{i , {k}_{2} ; j , l}$$

As a result, the appearance similarity aᵢⱼ is a value obtained by weighting and adding the similarity between the appearance feature amount pairs F_{i,k}, F_{j,l} using the correlation value as a weight. For this reason, as described above, for an object pair having appearance features that are not similar due to movement of the object, a change in direction, or the like, the similarity between the appearance feature amounts is less likely to be reflected in the final appearance similarity aᵢⱼ, and the influence of the movement of the object or the change in direction on the appearance similarity aᵢⱼ can be reduced.

In one example, the modulation function H can be a function that outputs a maximum value as follows.

$$\begin{matrix}[ Math . 7 ] & \\ {r}_{i , k ; j , l} = \{ \begin{matrix}1 , if {s}_{i , k ; j , l} > {s}_{i , {k}^{′} ; j , {l}^{′}} , {k}^{′} \neq k or {l}^{′} \neq l \\ 0 , otherwise\end{matrix} & ( 7 )\end{matrix}$$

In another example, the modulation function H can be the following softmax function.

$$\begin{matrix}[ Math . 8 ] & \\ {r}_{i , k ; j , l} = {e}^{{s}_{i , k ; j , l}} / {\sum }_{{k}^{′} , {l}^{′}} {e}^{{s}_{i , {k}^{′} ; j , {l}^{′}}} & ( 8 )\end{matrix}$$

The similarity aggregation unit 132 outputs the calculated appearance similarity aᵢⱼ to the fragment pair similarity calculation unit 120.

Next, calculation of coordinate similarity will be described. The fragment pair similarity calculation unit 120 outputs a coordinate information pair P2(i,j) to the coordinate similarity calculation unit 140. The coordinate information pair P2(i,j) includes coordinate information obj^{˜}_{i,j}. Here, the coordinate information obj^{˜}_{i,j} is obtained by removing the appearance feature amount F_{i,j} from the object information obj_{i,j}. That is, the coordinate information obj^{˜}_{i,j} includes the frame index (time) t_{i,j} and the coordinate (bounding box) information B_{i,j}.

The coordinate similarity calculation unit 140 calculates the coordinate similarity using the coordinate information pair P2(i,j). Specifically, the coordinate similarity calculation unit 140 assumes that the center coordinates of the bounding box linearly move at a constant velocity with respect to each of the trajectory fragments constituting the trajectory fragment pair, and extrapolates the bounding box until the intermediate time of the two trajectory fragments. At this time, regarding the shape (width and height) of the bounding box, it is assumed that the shape of the end point of the trajectory fragment does not change. Next, the coordinate similarity calculation unit 140 calculates an intersection over union (IoU) between bounding boxes extrapolated from both trajectory fragments at the intermediate time, and sets the calculated value as a coordinate similarity bᵢⱼ. Then, the coordinate similarity calculation unit 140 outputs the calculated coordinate similarity bᵢⱼ to the fragment pair similarity calculation unit 120.

The similarity integration unit 150 receives the appearance similarity degree aᵢⱼ and the coordinate similarity bᵢⱼ from the fragment pair similarity calculation unit 120, and calculates their linear combination cᵢⱼ as follows.

$$\begin{matrix}[ Math . 9 ] & \\ {c}_{ij} = λ {a}_{ij} + ( 1 - λ ) {b}_{ij} & ( 9 )\end{matrix}$$

Note that “λ” is a coefficient for integrating the appearance similarity aᵢⱼ and the coordinate similarity bᵢⱼ.

Then, the similarity integration unit 150 outputs the calculated linear combination cᵢⱼ to the fragment pair similarity calculation unit 120 as the integrated similarity degree.

Based on the integrated degree of similarity cᵢⱼ, the fragment pair similarity calculation unit 120 outputs a similarity C between the following trajectory fragment pairs to the optimal trajectory calculation unit 160.

$$\begin{matrix}[ Math . 10 ] & \\ c = \{ {c}_{ij} \vert 1 \leq i , j \leq N \} & ( 10 )\end{matrix}$$

The optimal trajectory calculation unit 160 calculates an optimal combination of trajectory fragments based on the similarity C between the trajectory fragment pairs, and outputs an optimal trajectory, that is, a set T of complete object trajectories of each object. Specifically, the optimal trajectory calculation unit 160 obtains an optimal trajectory by solving the following constrained optimization problem using the mathematical optimization solver.

### (1) Variable

A variable xᵢⱼ having a value of 0 or 1 is defined for each trajectory fragment pair P1(i,j), and indicates whether two trajectory fragments constituting the trajectory fragment pair P1(i,j) are temporally adjacent trajectory fragments in a single trajectory (that is, xᵢⱼ=1) or not (that is, xᵢⱼ=0). Note that the case of xᵢⱼ=0 includes a case where two trajectory fragments belong to trajectories of different objects, and a case where two trajectory fragments belong to a single trajectory (are the same object), but there is another trajectory fragment between the two trajectory fragments on the trajectory.

### (2) Constraint Condition

In a case where the temporal consistency is not established (in a case where i and j have temporal overlap: xᵢⱼ=0), the objects are not divided or combined. That is, a certain trajectory fragment is connected to at most one trajectory fragment at a time before that. This is expressed by the following mathematical expression.

$$\begin{matrix}[ Math . 11 ] & \\ {\sum }_{i ∈ P ( j )} {x}_{ij} \leq 1 & ( 11 )\end{matrix}$$

where P (j) is a set of trajectory fragments at a time before j.

In addition, a certain trajectory fragment is connected to at most one trajectory fragment at a time after that.

### (3) Optimization Objective Function

The following function is an objective function.

$$\begin{matrix}[ Math . 12 ] & \\ max {\sum }_{( i , j )} {c}_{ij} {x}_{ij} & ( 12 )\end{matrix}$$

In this way, the optimal trajectory calculation unit 160 outputs the set T of complete object trajectories of each object based on the similarity C between the trajectory fragment pairs.

### (Estimation Processing)

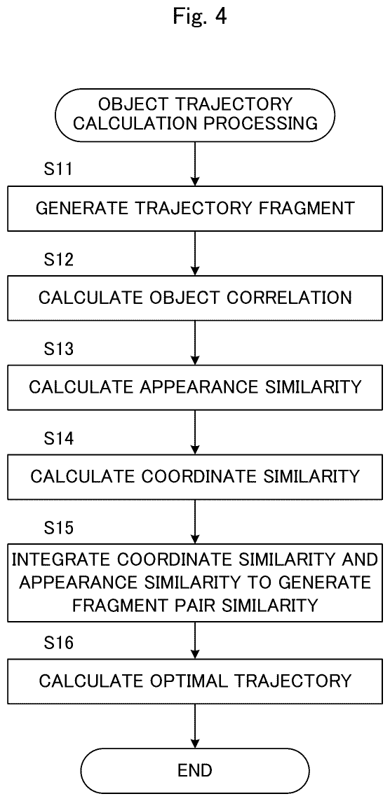

Next, object trajectory calculation processing by the information processing device 100 will be described. FIG. 4 is a flowchart of the object trajectory calculation processing. This processing is achieved by the processor 11 illustrated in FIG. 2 executing a program prepared in advance and operating as each element illustrated in FIG. 3.

First, the trajectory fragment generation unit 110 generates trajectory fragments from the input time-series frame images (step S11). Next, the correlation calculation unit 131 calculates an object correlation based on the trajectory fragment pair input from the fragment pair similarity calculation unit 120 (step S12). Next, the similarity aggregation unit 132 aggregates the object correlation and the appearance feature amount pair input from the fragment pair similarity calculation unit 120 to calculate the appearance similarity (step S13).

In addition, the coordinate similarity calculation unit 140 calculates the coordinate similarity based on the coordinate information pair input from the fragment pair similarity calculation unit 120 (step S14). Note that steps S12 to S13 and step S14 may be performed in the reverse order or may be performed in parallel in time.

Next, the similarity integration unit 150 integrates the coordinate similarity degree and the appearance similarity degree to generate a similarity degree between the trajectory fragment pair (step S15). Then, the optimal trajectory calculation unit 160 calculates and outputs an optimal trajectory based on the similarity between the trajectory fragment pairs (step S16). Then, the object trajectory calculation processing ends.

### Application Example

The information processing of the present disclosure can be applied to, for example, action management of a person, a robot, or the like in an industrial site or the like. Specifically, the method of the present disclosure can be used for automation of warehouses in the distribution industry, efficiency improvement of stores in the retail industry, efficiency improvement of site management in the construction industry, automation of inspections in the manufacturing industry, or the like.

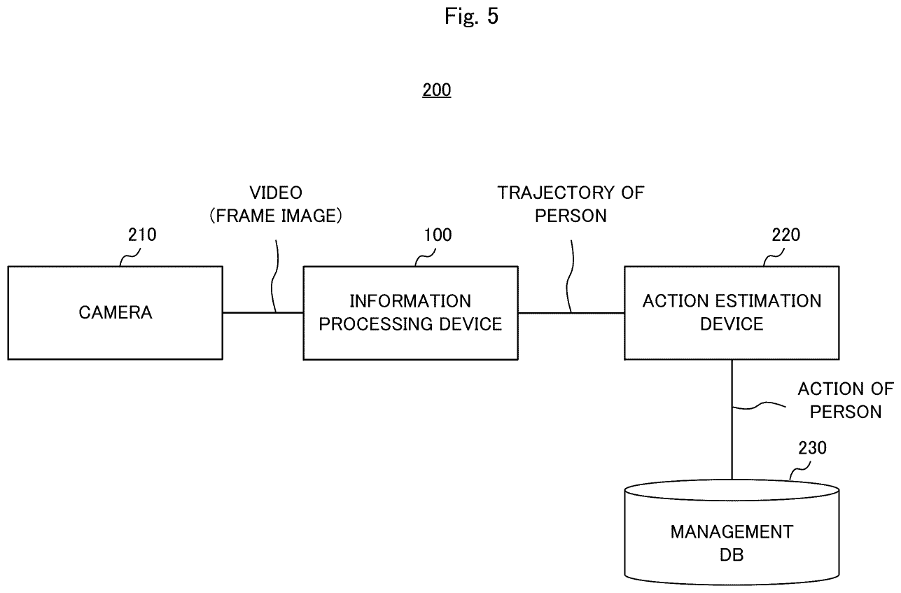

FIG. 5 illustrates an example of an action management system to which the information processing device of the present disclosure is applied. An action management system 200 includes a camera 210, the above information processing device 100, an action estimation device 220, and a management DB 230. The camera 210 is installed at a site to be managed, captures a video of the site, and transmits the video to the information processing device 100. The information processing device 100 tracks a person working at the site by the above-described method, and transmits the trajectory of the person to the action estimation device 220.

The action estimation device 220 estimates what action and work each person is doing based on the input trajectory of the person. The action estimation device 220 can use, for example, a deep learning model learned in advance to estimate the action of the person in the video from the input trajectory of the person. Then, the action estimation device 220 associates the estimated action of each person with time, a position at the site, or the like, and records the action in the management DB 230 as an action history. As a result, the manager at the site can manage the worker based on the action history of each person recorded in the management DB 230.

### Second Example Embodiment

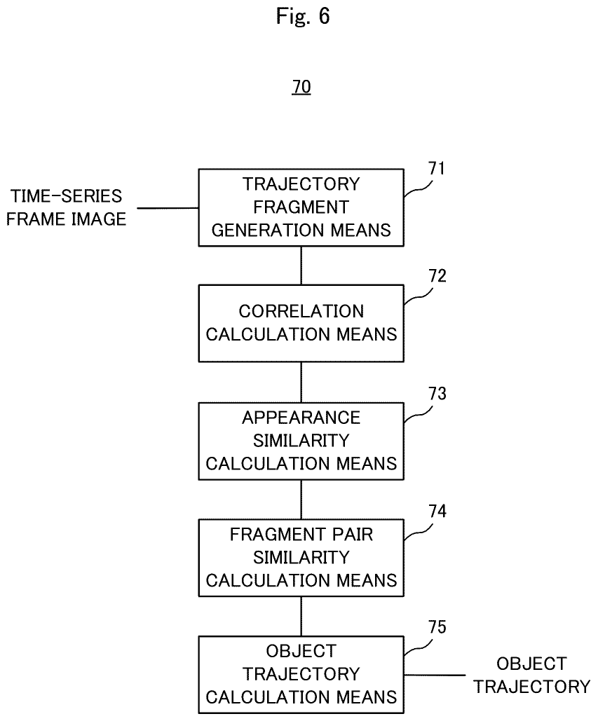

FIG. 6 is a block diagram illustrating a functional configuration of an information processing device according to another example of the present disclosure. An information processing device 70 includes a trajectory fragment generation means 71, a correlation calculation means 72, an appearance similarity calculation means 73, a fragment pair similarity calculation means 74, and an object trajectory calculation means 75.

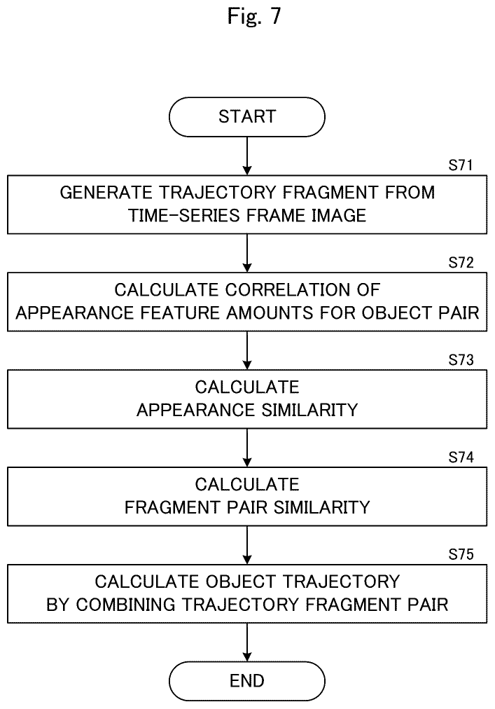

FIG. 7 is a flowchart of processing by the above information processing device. The trajectory fragment generation means 71 generates a trajectory fragment indicating at least a part of the trajectory in which the object included in the time-series frame image moves and including object information indicating the time, coordinates, and appearance feature amount in each frame image of the object (step S71). The correlation calculation means 72 calculates a correlation of the appearance feature amounts for an object pair formed by extracting an object one by one from each of a first trajectory fragment and a second trajectory fragment included in a trajectory fragment pair that is a pair of the trajectory fragments (step S72). The appearance similarity calculation means 73 calculates the appearance similarity of the trajectory fragment pair based on the correlation and the similarity between the appearance feature amounts of the object pair (step S73).

The fragment pair similarity calculation means 74 calculates a fragment pair similarity that is a similarity between the first trajectory fragment and the second trajectory fragment, using the appearance similarity (step S74). Then, the object trajectory calculation means 75 combines a plurality of trajectory fragment pairs based on the fragment pair similarity to calculate an object trajectory for the same object (step S75).

According to the above information processing device 70, it is possible to correctly track the same object in consideration of a change in appearance due to movement, a change in direction, or the like of the object.

Some or all of the above-described example embodiments may be described as the following Supplementary Notes, but are not limited to the following Supplementary Notes.

### (Supplementary Note 1)

An information processing device comprising:
a trajectory fragment generation configured to generate a trajectory fragment indicating at least a part of a trajectory in which an object included in a time-series frame image moves and including object information indicating time, coordinates, and an appearance feature amount in each frame image of the object;
a correlation calculation means configured to calculate a correlation of the appearance feature amounts for an object pair formed by extracting an object one by one from each of a first trajectory fragment and a second trajectory fragment included in a trajectory fragment pair that is a pair of the trajectory fragments;
an appearance similarity calculation means configured to calculate an appearance similarity of the trajectory fragment pair based on the correlation and a similarity between appearance feature amounts of the object pair;
a fragment pair similarity calculation means configured to calculate a fragment pair similarity that is a similarity between the first trajectory fragment and the second trajectory fragment by using the appearance similarity; and
an object trajectory calculation means configured to combine a plurality of trajectory fragment pairs based on the fragment pair similarity to calculate an object trajectory for the same object.

### (Supplementary Note 2)

The information processing device according to supplementary note 1, further including:
a coordinate similarity calculation means that calculates coordinate similarity indicating consistency of time and coordinate included in each of the first trajectory fragment and the second trajectory fragment, wherein
the fragment pair similarity calculation means calculates the fragment pair similarity based on the appearance similarity and the coordinate similarity.

### (Supplementary Note 3)

The information processing device according to supplementary note 1, wherein the appearance similarity calculation means calculates the appearance similarity by weighting and adding similarity between appearance feature amounts of a plurality of object pairs using the correlation as a weight.

### (Supplementary Note 4)

The information processing device according to supplementary note 3, wherein the appearance similarity calculation means sets a weight of a maximum value of the correlation to 1 and sets a weight of a correlation other than the maximum value to 0.

### (Supplementary Note 5)

The information processing device according to supplementary note 3, wherein the appearance similarity calculation means calculates the weight by inputting a value of the correlation to a softmax function.

### (Supplementary Note 6)

The information processing device according to supplementary note 1, wherein the correlation calculation means calculates an inner product or a cosine similarity of the appearance feature amounts of the object pair as the correlation.

### (Supplementary Note 7)

The information processing device according to supplementary note 1, wherein the correlation calculation means calculates the correlation by inputting object information of the object pair to a neural network learned in advance.

### (Supplementary Note 8)

The information processing device according to supplementary note 1, wherein the object trajectory calculation means calculates the object trajectory by connecting a plurality of pairs of temporally adjacent trajectory fragments in a single trajectory of the same object.

### (Supplementary Note 9)

An information processing method executed by a computer, the method comprising:

generating a trajectory fragment indicating at least a part of a trajectory in which an object included in a time-series frame image moves and including object information indicating time, coordinates, and an appearance feature amount in each frame image of the object;
calculating a correlation of the appearance feature amounts for an object pair formed by extracting an object one by one from each of a first trajectory fragment and a second trajectory fragment included in a trajectory fragment pair that is a pair of the trajectory fragments;
calculating an appearance similarity of the trajectory fragment pair based on the correlation and a similarity between appearance feature amounts of the object pair;
calculating a fragment pair similarity that is a similarity between the first trajectory fragment and the second trajectory fragment by using the appearance similarity; and combining a plurality of trajectory fragment pairs based on the fragment pair similarity to calculate an object trajectory for the same object.

### (Supplementary Note 10)

A program causing a computer to execute processing of:
generating a trajectory fragment indicating at least a part of a trajectory in which an object included in a time-series frame image moves and including object information indicating time, coordinates, and an appearance feature amount in each frame image of the object;
calculating a correlation of the appearance feature amounts for an object pair formed by extracting an object one by one from each of a first trajectory fragment and a second trajectory fragment included in a trajectory fragment pair that is a pair of the trajectory fragments;
calculating an appearance similarity of the trajectory fragment pair based on the correlation and a similarity between appearance feature amounts of the object pair;
calculating a fragment pair similarity that is a similarity between the first trajectory fragment and the second trajectory fragment by using the appearance similarity; and
combining a plurality of trajectory fragment pairs based on the fragment pair similarity to calculate an object trajectory for the same object.

Some or all of the configurations described in supplementary notes 2 to 8 dependent on the above-described supplementary note 1 can also be dependent on supplementary notes 9 and 10 by the same dependency relationship as in supplementary notes 2 to 8. Furthermore, some or all of the configurations described as the supplementary notes can be similarly dependent on not only the supplementary notes 1, 9, and 10, but also various pieces of hardware and software, and various recording means or systems for recording software without departing from the above-described example embodiments.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

11 Processor
100 Information processing device
110 Trajectory fragment generation unit
120 Fragment pair similarity calculation unit
130 Appearance similarity calculation unit
131 Correlation calculation unit
132 Similarity aggregation unit
140 Coordinate similarity calculation unit
150 Similarity integration unit
160 Optimal trajectory calculation unit

1. An information processing device comprising:
at least one memory configured to store instructions; and
at least one processor configured to execute the instructions to:
generate a trajectory fragment indicating at least a part of a trajectory in which an object included in a time-series frame image moves and including object information indicating time, coordinates, and an appearance feature amount in each frame image of the object;
calculate a correlation of the appearance feature amounts for an object pair formed by extracting an object one by one from each of a first trajectory fragment and a second trajectory fragment included in a trajectory fragment pair that is a pair of the trajectory fragments;
calculate an appearance similarity of the trajectory fragment pair based on the correlation and a similarity between appearance feature amounts of the object pair;
calculate a fragment pair similarity that is a similarity between the first trajectory fragment and the second trajectory fragment by using the appearance similarity; and
combine a plurality of trajectory fragment pairs based on the fragment pair similarity to calculate an object trajectory for the same object.

2. The information processing device according to claim 1, wherein the processor is further configured to calculate coordinate similarity indicating consistency of time and coordinate included in each of the first trajectory fragment and the second trajectory fragment, wherein
the processor calculates the fragment pair similarity based on the appearance similarity and the coordinate similarity.

3. The information processing device according to claim 1, wherein the processor calculates the appearance similarity by weighting and adding similarity between appearance feature amounts of a plurality of object pairs using the correlation as a weight.

4. The information processing device according to claim 3, wherein the processor sets a weight of a maximum value of the correlation to 1 and sets a weight of a correlation other than the maximum value to 0.

5. The information processing device according to claim 3, wherein the processor calculates the weight by inputting a value of the correlation to a softmax function.

6. The information processing device according to claim 1, wherein the processor calculates an inner product or a cosine similarity of the appearance feature amounts of the object pair as the correlation.

7. The information processing device according to claim 1, wherein the processor calculates the correlation by inputting object information of the object pair to a neural network learned in advance.

8. The information processing device according to claim 1, wherein the processor calculates the object trajectory by connecting a plurality of pairs of temporally adjacent trajectory fragments in a single trajectory of the same object.

9. An information processing method executed by a computer, the method comprising:
generating a trajectory fragment indicating at least a part of a trajectory in which an object included in a time-series frame image moves and including object information indicating time, coordinates, and an appearance feature amount in each frame image of the object;
calculating a correlation of the appearance feature amounts for an object pair formed by extracting an object one by one from each of a first trajectory fragment and a second trajectory fragment included in a trajectory fragment pair that is a pair of the trajectory fragments;
calculating an appearance similarity of the trajectory fragment pair based on the correlation and a similarity between appearance feature amounts of the object pair;
calculating a fragment pair similarity that is a similarity between the first trajectory fragment and the second trajectory fragment by using the appearance similarity; and
combining a plurality of trajectory fragment pairs based on the fragment pair similarity to calculate an object trajectory for the same object.

10. A non-transitory computer-readable recording medium storing a program causing a computer to execute processing of:
generating a trajectory fragment indicating at least a part of a trajectory in which an object included in a time-series frame image moves and including object information indicating time, coordinates, and an appearance feature amount in each frame image of the object;
calculating a correlation of the appearance feature amounts for an object pair formed by extracting an object one by one from each of a first trajectory fragment and a second trajectory fragment included in a trajectory fragment pair that is a pair of the trajectory fragments;
calculating an appearance similarity of the trajectory fragment pair based on the correlation and a similarity between appearance feature amounts of the object pair;
calculating a fragment pair similarity that is a similarity between the first trajectory fragment and the second trajectory fragment by using the appearance similarity; and
combining a plurality of trajectory fragment pairs based on the fragment pair similarity to calculate an object trajectory for the same object.
